(19) United States
(12) Patent Application Publication
(10) Pub. No.: US 2010/0037511 A1
(43) Pub. Date: Feb. 18, 2010

(54) Extendable pest swatter with interchangeable appliances

(76) Inventor: Jeffrey Thomas Schier, Missouri City, TX (US)

Correspondence Address: Jeffrey Thomas Schier, 7807 Spirit Hollow Ct., Missouri City, TX, 77459, US

(21) Appl. No.: 12/228,688

(22) Filed: Aug. 15, 2008

(51) Int. Cl. A01M 3/02

(52) U.S. Cl. 43/137

(57) ABSTRACT

An extendable pest swatter operable to interface with a pest that includes a handle, a plurality of interlocking conical sections coupled to the handle, wherein each of the interlocking conical sections are formed with a first end and a second end and the first end of one interlocking conical section interlocks with the second end of the adjoining interlocking conical section, a connecting adaptor formed into the second end of the last interlocking conical section, and a utility receptor coupled to the connecting adaptor for interfacing with the pest.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Extendable pest swatter with interchangeable appliances is designed to be preferably used in the pest control and home/business maintenance arenas. Advantages of the extendable pest swatter that may be present in some embodiments of the invention include self-supporting interlocking conical sections to extend the device from the handle, interchangeable appliances for cleaning up of pest remains and facilitating the removal of nests, webs and other habitations left behind by pests that are located in hard-to-reach places.

### BRIEF SUMMARY OF THE INVENTION

In some embodiments, the extendable pest swatter with interchangeable appliances is designed to be used by individuals for the extermination of insects and other pests, which may include, but not limited to, flying and other insects and pests including those that crawl into hard to reach places (collectively, referred to as “Pests”). In other embodiments, the extendable pest swatter with interchangeable appliances may be used for the clean-up of such exterminated Pests around the home and business and for other hard-to-reach areas for cleaning needs (such as the Pests' habitations) around the home and business.

Though an extendable flyswatter has been patented (U.S. Pat. No. 4,120,114), the extendable pest swatter with interchangeable appliances has advantages and improvements in certain embodiments of the invention, in the following ways:
The extendable pest swatter utilizes a conically extending series of extender sections which are capable of interlocking at varying lengths and do not require a separate locking mechanism. Previous extending flyswatters such as the previously patented extending flyswatter include a straight, telescopically extending tubular handle that requires a latch to lock the swatter in the extended position; further this design can only be extended to only one length.
In some embodiments, the extendable pest swatter utilizes interchangeable appliances, also referred to as utility receptors, which enables the extendable pest swatter to have additional functionalities including as a utilitarian, extendable, household cleaning device. Examples of utility receptors include, but are not limited to, swatting nets, scrapes, brushes, stamps or other end attachments that can be used to handle pests or other items in elevated or hard-to-reach locations including cleaning extinguished pests from elevated locations where they have been swatted but remain affixed to the wall/ceiling.

In some embodiments of the invention, the extendable pests swatter has been designed to assist all people, but may be particularly able to assist elderly, wheelchair-bound or any individual that needs to reach items beyond their arm length to eliminate Pests. The utility receptors, being interchangeable appliances, may also allow for the stamping of the Pests when a swatting action is not possible (though you could not stamp too hard with compromising the integrity of the extending sections). In other configurations of certain embodiments of the invention, the utility receptors permit clean-up of the Pests after termination by scraping, brushing, or scooping from the applicable surface.

In some embodiments of the invention, the following objectives may be achieved:
Convenience for the user
Multi-tasking orientation of the invention
Simplicity in design
Inexpensive manufacturing costs
Lightweight but rugged construction
Inexpensive distribution costs due to compactable size and light weight

### BRIEF DESCRIPTION OF THE SEVERAL VIEWS OF THE DRAWING

A more complete understanding of the present embodiment and advantages thereof may be acquired by referring to the following description taken in conjunction with accompanying drawings, in which like reference numbers indicate like features, and wherein:

FIG. 1 depicts an example embodiment of an extendable pest swatter in a retracted position having a swatting utility receptor connected with the extendable pest swatter.

FIG. 2 depicts an example embodiment of the extendable pest swatter in an extended position showing the swatting utility receptor detached from the extendable handle portion.

FIG. 3 depicts an example embodiment of stamper utility receptor.

FIG. 4 depicts an example embodiment of brush utility receptor.

FIG. 5 depicts an example embodiment of scraper utility receptor.

FIG. 6 illustrates one example embodiment of the extendable pest swatter using the swatting utility receptor to swat a pest located on a wall.

FIG. 7 illustrates one example embodiment of the extendable pest swatter using the stamping utility receptor to stamp a pest located on a ceiling.

FIG. 8 illustrates one example embodiment of the extendable pest swatter using the scraping utility receptor to scrap the remains of a pest from the ceiling that has been stamped.

FIG. 9 illustrates one example embodiment of the extendable pest swatter using the brush utility receptor to remove a cobweb from a hard-to-reach location such as a corner of the wall and ceiling.

FIGS. 10A and 10B illustrate one example embodiment of the extendable pest swatter moving from a closed position to an extended position.

FIGS. 11A and 11B illustrate another example embodiment of the extendable pest swatter extending from a closed position to an extended position.

### DETAILED DESCRIPTION OF THE INVENTION

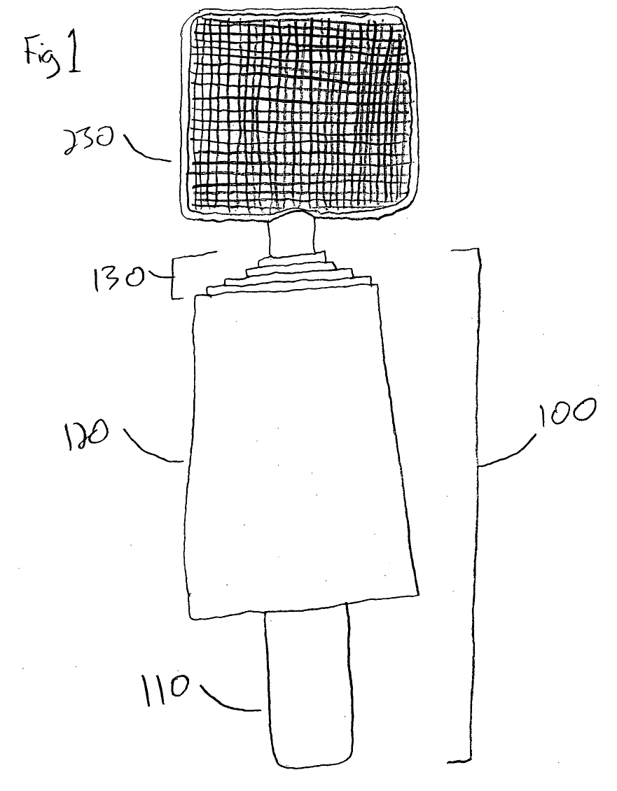

Preferred embodiments and their advantages are best understood by reference to FIGS. 1 through 1B, wherein like numbers are used to indicate like and corresponding parts.

In FIG. 1, an example embodiment of extendable pest swatter 100 is shown in a retracted position. Extendable pest swatter preferably includes handle 110 that is connected with first tube section 120. First tube section 120 is the fixed portion of extendable pest swatter 100, which can be grasped by a user while in the retracted position.

A plurality of retracted extending sections 130 shown in the retracted position are nested within each other and contained within first tube section 120. In this embodiment, extendable pest swatter 100 has swatting utility receptor 230 connected with the retracted extending sections 130.

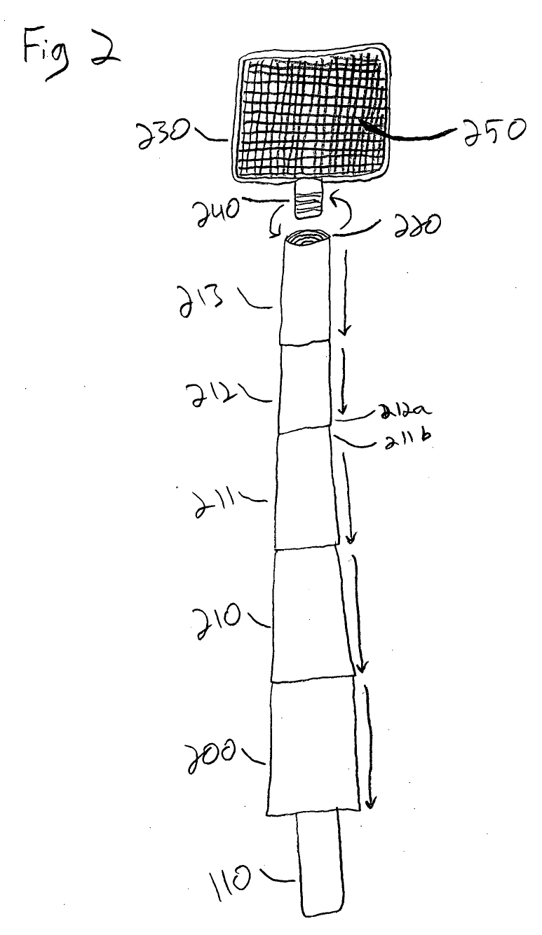

In FIG. 2, extendable pest swatter 100 has been fully extended showing the interlocking conical sections 210 retractably extending from handle 110 with connecting tube section 200 connected with handle 110. Interlocking conical sections 210, 211, 212, 213 generally are sequentially smaller and smaller tube sections with the end of each section distal from handle 110 being the smaller portion of that interlocking conical section 210, 211, 212, 213. And, each section further from handle 110 is a slightly smaller tube than the previous section with the distal portion of the previous section being smaller than the outer end of the next section to allow for interlocking of the sections. For example, the distal end of interlocking tube sections 211b has a smaller interior diameter than the outer diameter of end portion 212a on interlocking conical section 212. As such, the two interlocking conical sections 211 and 212 are retractably extended from handle 110.

In certain embodiments of the present invention, interlocking conical sections 210, 211, 212, 213 are formed in a plastic injectable mold.

At the distal end of interlocking conical section 213 is connecting adaptor 220. Connecting adaptor 220 is shown in this example embodiment as a screw-type receptor. However, in other embodiments, connecting adaptor 220 may be formed from a variety of connecting devices such as a quick release locking mechanism or some other attachment method.

Swatting utility receptor 230 is shown detached from connecting adaptor 220. As with this example embodiment, swatting utility receptor 230 has mating end 240 to couple with connecting adaptor 220. In this instance, mating end 240 is formed as a screw with mating threads to connect to adaptor 220.

Swatting utility receptor 230 also preferably includes stiff netting area 250. Netting area 250 typically has small openings to allow air to pass through but still small enough to swat the Pests. However, in certain instances, netting area 250 may be formed as on solid section.

To extend extendable pest swatter 100, a user either: i) grasps handle 110 and swings extendable pest swatter 100 in a quick throwing motion causing a momentum force to pull interlocking tube sections 210, 211, 212, 213 into a locking position, or ii) manually extends the sections 210, 211, 212, 213 by pulling the terminal section of the swatter distally from the handle 110 until interlocking tube sections 210, 211, 212, 213 are in a locking position. To retract interlocking tube sections 210, 211, 212, 213, the user will manually compress extendable pest swatter 100 causing handle 110 to move toward the utility receptor end, in this instance, swatting utility receptor 230 (as shown along arrow lines).

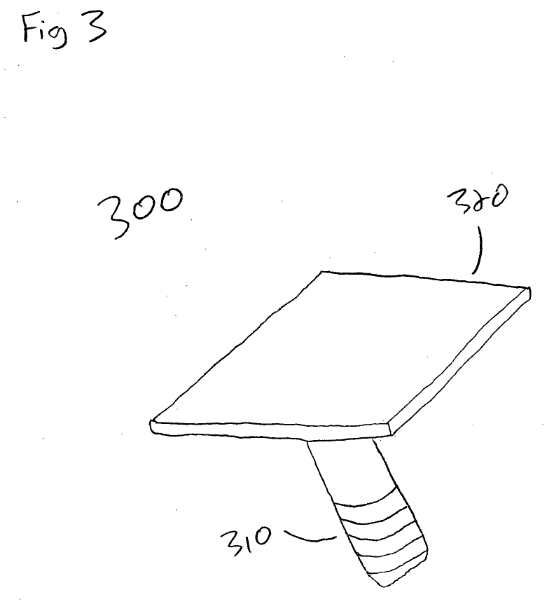

In FIG. 3, an example embodiment of stamper utility receptor 300 is shown. Stamper utility receptor 300 generally includes stamping mating adaptor 310 that will connect with connecting adaptor 220. Again, stamping mating adaptor 310 shown in this instance as being formed with the screw-type mating connector with threads; however, other connector may be used with stamper utility receptor 300.

Stamping end 320 is typically a flat surface that can be used to stamp a pest. In some embodiments, stamping end may be angled to allow for stamping a pest on a ceiling; however, in this instance, the face of stamping end 320 is formed perpendicular to extending portion of extending pest swatter 100.

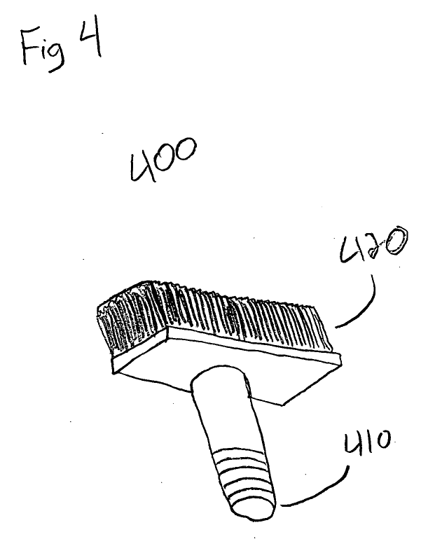

In FIG. 4, an example embodiment of brush utility receptor 400 is shown. Brush utility receptor 400 generally includes brush mating adaptor 410 that will connect with connecting adaptor 220. Again, brush mating adaptor 410 shown in this instance as being formed with the screw-type mating connector with threads; however, other connector may be used with brush utility receptor 400.

Brush 420 is affixed at the end of brush utility receptor 400 opposite from brush utility receptor 410. In some embodiments, brush 420 may be angled to aid the user.

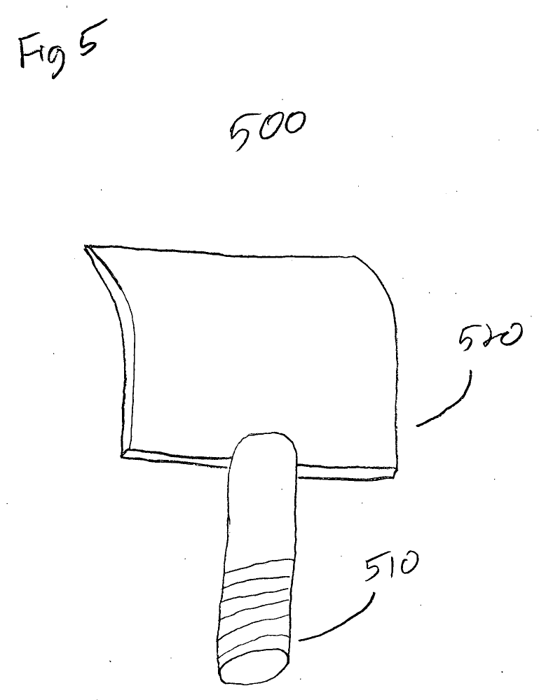

In FIG. 5, an example embodiment of scraper utility receptor 500 is shown. Scraper utility receptor 500 generally includes scraper mating adaptor 510 that will connect with connecting adaptor 220. Again, scraping mating adaptor 510 shown in this instance as being formed with the screw-type mating connector with threads; however, other connector may be used with scraping utility receptor 500.

Scraper 520 is affixed at the end of scraper utility receptor 500 opposite from scraper utility receptor 510. In some embodiments, scraper 520 may be angled or curved to aid the user in removing the pest from a surface. Further, scraper 520 may also be formed in a variety of shapes and sizes and from a variety of materials.

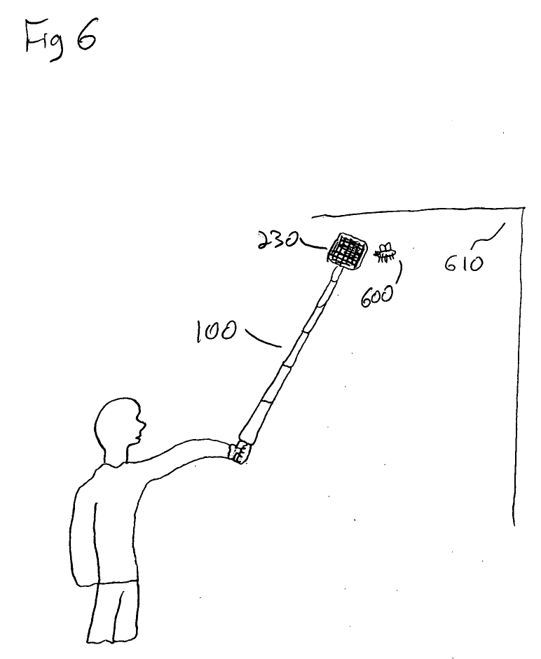

In FIG. 6, one example embodiment of extendable pest swatter 100 is shown in the extended position with swatting utility receptor 230. In this instance, a user is pursuing pest 600 with swatting utility receptor 230 in the hopes of eliminating pest 600. Typically, pest 600 may be swatted against wall 610 to cause such elimination.

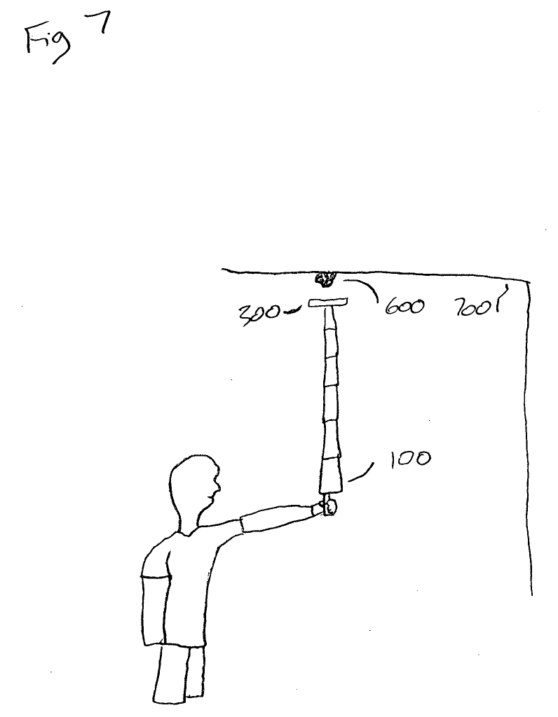

FIG. 7 illustrates one example of a user using extendable pest swatter 100 with stamping utility receptor 300 to stamp out or eliminate pest 600 that is located on ceiling 700. With the aid of the extended reach of extendable pest swatter 100, the user can reach such pest 600 located in such high, hard-to reach places. As a note of caution, the user only uses enough force to stamp out pest 600 but not enough force to cause compression of interlocking tube sections 210, 211, 212, 213, thus retracting extendable pest swatter 100.

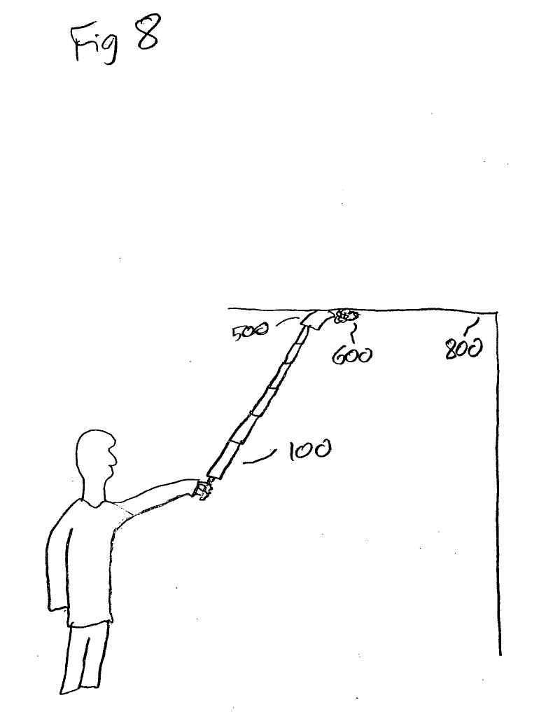

In FIG. 8, a user illustrates one example embodiment of extendable pest swatter 100 being used with scraping utility receptor 500 to scrape the remains of pest 600 from ceiling 800. Typically, scraping utility receptor 500 is most useful after pest 600 has been eliminated or stamped against ceiling 800.

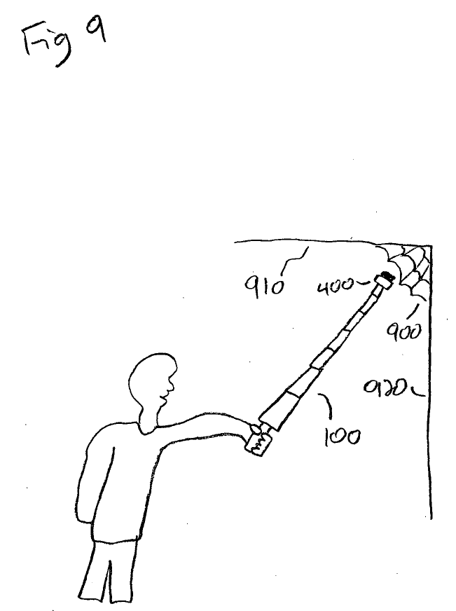

In FIG. 9, a user shows an example embodiment of extendable pest swatter 100 using brush utility receptor 400 to remove cobweb 900 from a hard-to-reach location such as a corner of wall 920 and ceiling 910.

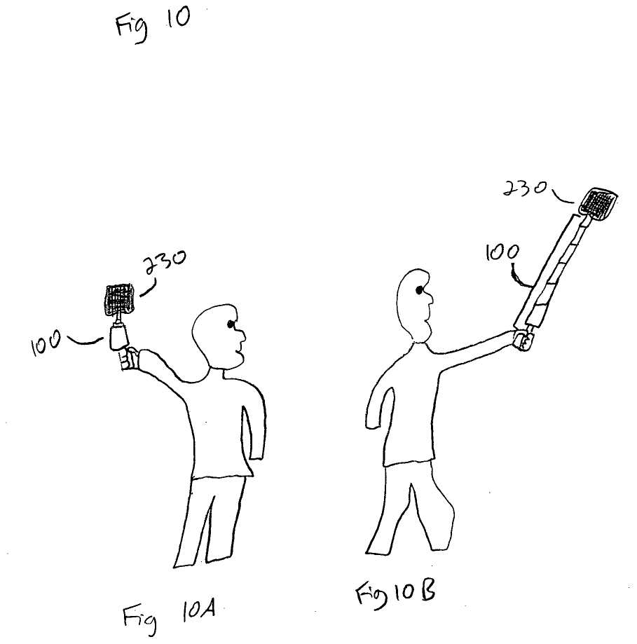

In FIG. 10A, a user is shown in an example embodiment to be holding extendable pest swatter 100 with attached utility receptor 230 in a closed position, namely not extended. While keeping a grip on handle 110, the user projects extendable pest swatter 100 in a strong motion and then quickly stops the motion after a short distance. The strong motion can be generated either in a linear motion or a circular (e.g., centrifugal or centripetal motion). The force of the movement causes interlocking tube sections 210, 211, 212, 213 to slide out and interlock in an extended position, as shown in FIG. 10B.

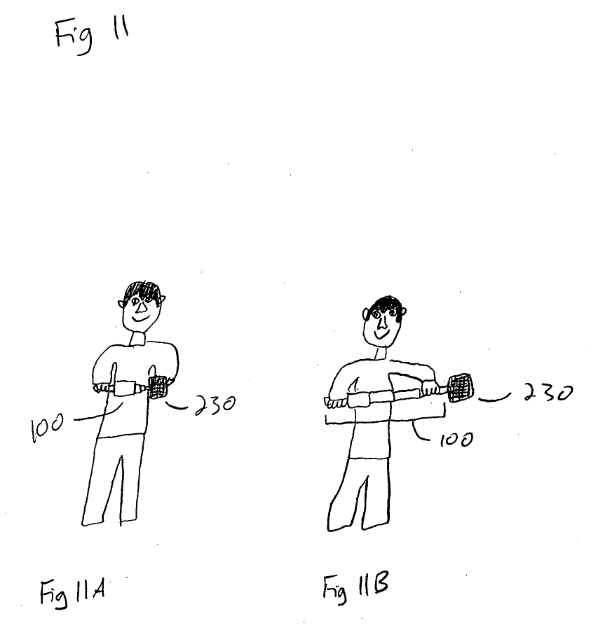

In FIG. 11A, a user is shown in a second example embodiment to be holding extendable pest swatter 100 with attached utility receptor 230 in a closed position, namely not extended. While keeping a grip on handle 110 with one hand and placing another hand on extendable pest swatter 100 at the distal portion of the extending conical sections, namely interlocking tube sections 210, 211, 212, 213, the user extends the interlocking tube sections 210, 211, 212, 213 into an extended position that interlocks the section in an extended position, as shown in FIG. 11B.

Although the disclosed embodiments have been described in detail, it should be understood that various changes, substitutions and alterations can be made to the embodiments without departing from their spirit and scope.

1. An extendable pest swatter operable to interface with a pest, comprising:
a handle;
a plurality of interlocking conical sections coupled to the handle, wherein each of the interlocking conical sections are formed with a first end and a second end and the first end of one interlocking conical section interlocks with the second end of the adjoining interlocking conical section;
a connecting adaptor formed into the second end of the last interlocking conical section;
a utility receptor coupled to the connecting adaptor for interfacing with the pest.

2. The swatter of claim 1, wherein the utility receptor is a swatting utility receptor.

3. The swatter of claim 1, wherein the utility receptor is a stamping utility receptor.

4. The swatter of claim 1, wherein the utility receptor is a scraping utility receptor.

5. The swatter of claim 1, wherein the utility receptor is a brush utility receptor.

6. The swatter of claim 1, wherein the connecting adaptor is a screw-type connector.

7. The swatter of claim 1, wherein the plurality of interlocking sections are constructed from a plastic injectable mold.

8. A method of extending an extendable pest swatting device comprising: grasping the handle portion of the device;
projecting the device with a strong motion; and
stopping the motion quickly, whereby the force of the motion and quick stop causes a plurality of interlocking conical sections to slide along each other and interlock the device into an extended position.

9. The method of claim 8, whereby the motion is generated by circular motion.

10. The method of claim 8, whereby the motion is generated by linear motion.

11. The method of claim 8, further comprising attaching a utility receptor to the device for interfacing with a pest.

12. The method of claim 11, wherein the utility receptor comprises a utility receptor selected from the following list: swatting utility receptor, stamping utility receptor, scraping utility receptor or a brush utility receptor.

13. A method of extending an extendable pest swatting device comprising:
grasping the handle portion of the device;
grasping a second portion of the device that is distal from the handle portion; and
extending the device into an extended position, whereby a plurality of interlocking conical sections to slide along each other and interlock the device into an extended position.

14. The method of claim 13, further comprising attaching a utility receptor to the device for interfacing with a pest.

15. The method of claim 14, wherein the utility receptor comprises a utility receptor selected from the following list: swatting utility receptor, stamping utility receptor, scraping utility receptor or a brush utility receptor.
